(19) United States
(12) Patent Application Publication
(10) Pub. No.: US 2011/0086208 A1
(43) Pub. Date: Apr. 14, 2011

(54) Lightweight, Breathable, Waterproof, Stretchable, Dye-Sublimatable Fabric For Apparel

(76) Inventors: Charles J. Nemphos, JR., Pasadena, MD (US); Robert Brendel, Ocean View, DE (US)

(21) Appl. No.: 12/889,055

(22) Filed: Sep. 23, 2010

Related U.S. Application Data
(60) Provisional application No. 61/249,655, filed on Oct. 8, 2009.

(51) Int. Cl. D03D 15/08; B32B 3/10; B32B 37/14; B32B 38/04

(52) U.S. Cl. 428/196; 442/183; 156/308.2; 156/250; 156/93

(57) ABSTRACT

A stretchable, waterproof, breathable, colored fabric particularly suited for athletic and outdoor use comprising an outer layer composed of a woven or knitted, dye-sublimated colored polyester elastomeric yarn, an intermediately disposed stretchable, breathable, and waterproof membrane, and a woven or knitted polypropylene elastomeric layer all being laminated to form a unitary fabric.

### FIELD OF THE INVENTION

This invention relates particularly to improvements in fabric for use in apparel disclosed in U.S. Pat. Nos. 5,631,074 and 5,415,924. This invention provides a fabric possessing all of enhanced comfort, performance, mobility, stretchability, waterproofnessess, breathability, warmth, moisture management, and wind resistance with the addition of colorability and patterning by dye sublimation with multiple colors and patterning. The sublimatable layer is bonded to a membrane which is turn is bonded to an underlying polypropylene layer. The resulting fabric is waterproof, breathable, stretchable, and capable of bearing desired imaging/coloration/patterning. The invention is particularly suited for apparel employed in outdoor activities involving exposure to adverse/inclement environmental conditions, e.g., temperature, moisture, wind, etc. while providing enhanced visual aesthetics.

### BACKGROUND

Bi-layer and tri-layer waterproof, breathable, stretchable, rugged fabrics for outdoor use have been described, respectively, in the aforementioned U.S. Pat. Nos. 5,631,074 and 5,415,924. These fabrics possess at least an outer shell of a fine sized, polypropylene filament/fiber blend with a laminated waterproof, breathable, stretchable layer which optionally may be laminated to a mesh lining. As discussed in the patents, extreme and outdoor sports, such as surfing, bicycling, skiing, climbing, spelunking, and the like involve a great deal of physical exertion and significant aerobic activity/motion on the part of a participant/athlete. Suitable apparel, preferably, has the capacity to wick moisture from the wearer's skin while maintaining a capacity for thermal insulation and desired waterproofing. Accordingly, apparel suitable for such activities should be rugged and embody certain performance criteria, as for example, being lightweight, colorfast, sunfast, waterproof, and resistant to odor, mold, and stains, providing high insulativity/low thermal conductivity, possess substantial elasticity, abrasion and wind resistance, high tensile strength, high vapor permeability/breathability, and shape recovery.

Due to its now recognized advantages, polypropylene has become a material of choice for fabrication of extreme outdoor apparel. As described in the above referenced patents, polypropylene fibers provide excellent wicking and moisture control in addition to its “soft-hand” when lying against skin. However, polypropylene is notoriously resistant to coloring and colorfastness, due in part to its low-melting/crystal transition temperature. Accordingly, fabrics comprising polypropylene do not lend themselves to clear bright consistent coloration and imaging by conventional dye sublimation. Commonly when exposed to elevated temperatures, polypropylene fibers soften and the fabric composed of the fibers will flatten out thereby compromising the fabric's physical structure as well as its performance. One technique used to impart color to polypropylene containing fabrics has been to combine with it pre-colored fibers of appropriate compatible materials. However, the incorporation of such fibers not only alters the performance characteristics of the polypropylene fabric, often reducing its soft hand, but also often results in composite fabric without consistent coloration.

Turning to a material well known for its ability to be dyed, the prior art contains numerous teachings and examples of use of and dying of polyester fibers and fabrics. U.S. Pat. Nos. 7,428,772 and 7,743,476 describe, for example, colored and pattered upholstered seats for commuters which, when desired may feature a three-dimensional knapped pattern. The fabric is breathable but as is evident from its described commuter upholstered function, is not and cannot be stretchable.

There still exists a need in the art for a fabric for constructing apparel which possesses all of the desired characteristics discussed above as well as providing desirable visual aesthetics by bearing multiple colors and patterns of any choice. While most prior art fabrics possess some of the above characteristics stretchability, breathable, warmth, moisture management, waterproofness, wind resistance, and colorability/printability and a few possess the majority thereof, no known fabric possesses all of the characteristics and the ability to include clearly pattered coloration.

### SUMMARY OF THE INVENTION

It is an object of the present invention to provide a fabric laminate for apparel possessing a range of desirable properties, which is particularly suitable for outdoor apparel, and possesses visually aesthetic features created by permanent multiple-coloration and patterning.

It is another object of this invention to provide a membraned polypropylene based textile with an outer layer of patterned/colored polyester by dye-sublimation bonded therewith.

It is an object of the present invention to provide a process for manufacture and use of stretchable, waterproof, breathable, custom printable apparel constructed from a laminated textile formed from a stretchable polypropylene layer, a dye-sublimated stretchable polyester fabric, and a flexible, elastomeric, waterproof, breathable membrane disposed there between.

These and other objects are satisfied by an improved breathable, stretchable, water-repellant, printed laminated fabric with a first layer comprised substantially of polypropylene filaments blended with elastomeric fibers, which layer substantially resists absorption of liquid water, and a second layer, laminated to said first layer, said second layer being stretchable and substantially impervious to liquid water but pervious to water vapor, the improvement comprising a third layer of dye-sublimatable, polyester-elastomer fiber blend accepting desired coloration and patterning.

Still other objects are satisfied by a method of making apparel comprising the steps of: fabricating a laminated fabric comprising a dye-sublimated, stretchable polyester-based layer, a waterproof and vapor permeable stretchable membrane, and a stretchable polypropylene-based layer, cutting and trimming the laminated fabric into discrete pieces, and attaching said discrete pieces by a known technique selected from the group consisting of sewing, gluing, and welding to form apparel.

The invention herein provides an improvement to the fabric described in U.S. Pat. Nos. 5,631,074 and 5,415,924, the content of which are incorporated by reference herein. The invention is a unique, utilitarian, laminated fabric specifically adapted for apparel used in a wide range of outdoor activities that allows for incorporation of any select color scheme/pattern/imaging. Durable, permanent colors and patterns are introduced by dye-sublimation of a polyester/elastomeric outer-shell layer of the laminated fabric.

As in the case of the above-referenced predecessor technology, the present invention preserves the benefits thereof including: stretchability, elasticity, shape recovery, low thermal conductivity/high thermal insulativity, vapor permeability (i.e., “breathabiltity”), and liquid impermeability. The inventive fabric is also lightweight, colorfast, sunfast, abrasion resistant, wind resistant, stain resistant, odor resistant, mold resistant, mildew and microbe resistant, as well as possessing high tensile strength, and colorability.

The improvement provided by this invention is to permit the apparel manufacturer to include desired integrated permanent colors and/or patterns to the fabric which may even be in the form of individualized customizable apparel which displays a specific array of team/sponsor logos and colors or more complex digitized photographically-based imaging/offset art images. Also, safety features may be added via the outer polyester layer such as high visibility/fluorescent colors, usable by first responders to provide for easy identification or, oppositely, camouflage patterns and coloration. Furthermore, the fabric may feature as a discrete layer or compounded with an existing layer, custom additives for protection against hazardous ambient conditions.

In short, the invention contemplates fabric comprising a laminated lightweight, polyester/elastomer layer possessing relatively high strength, abrasion and wind resistance, which has been dye sublimated with a select pattern and or colors, a flexible, stretchable, vapor permeable waterproof membrane itself being bonded to a flexible, stretchable, breathable, knitted or woven polypropylene/spandex layer of the type described in the above-referenced patents.

The following definitions are provided to assist in understanding the scope of the invention as described herein.

“Breathability” as used herein refers to gas permeability such as the moisture vapor transmission of a material as measured by ASTM E96 method BW with the test performed at 23° C. (73.4° F.), 50% Relative Humidity with a range of 6000-15000 MVT.

“Stretchable” means that a material can be stretched, without breaking, by at least 25% (to 125% of its initial, unstretched, length) in at least one direction, suitably by at least 50% (to 150% of its initial length), desirably by at least 100% (to at least 200% of its initial length). Preferably, the word stretchable applies to a capacity for biaxial elongation.

“Sublimation” is used to describe a technique to imprint indicia in the form of designs, logos, characters, etc. directly into the fabric generally by a process of thermal image transfer. Conventional sublimation dyes/inks include an inert carrier encapsulating the dye/colorant which is released into the underlying receiving surface, e.g., fabric upon application heat and/or pressure sufficient to induce a change-of-state, i.e., gasification of the dye to migrate into the fabric. Sublimation results in the penetration of the dye. Generally, sublimation describes the phase change transformation from a solid state to a vapor state whereupon sublimatable dyes/inks are transferred by heat and pressure from a source such as sheets or rolls to the target fabric.

“Waterproof” means that the fabric can withstand a water ingress pressure of more than 0.13 bar. Preferably, the fabric can withstand a water pressure of more than 1 bar. The measurement of hydrostatic resistance takes place by subjecting a sample of the fabric to be investigated with a surface area of 100 cm to an increasing water pressure based on the hydrostatic pressure test method described in ASTM D 751 Procedure A-1 with a range set at 25-85 PSI.

“Wicking” defines the capacity of the fabric for dispersing or spreading vertically or horizontally of moisture or liquid but not vapor through a given area, typically by capillary action. Wicking contemplates the capacity of the fabric to transport perspiration immediately to the fabric side facing away from the wearer's skin (wicking effect) so that the wearer avoids moisture accumulation on the skin and the accompanying feeling of wetness.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used in this application the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

In the following description, reference is made to the accompanying drawing, and which is shown by way of illustration to a specific embodiment in which the invention may be practiced. The following illustrated embodiment should make apparent an enable those skilled in the art to practice the invention. It is to be understood that other embodiment may be utilized and that structural changes based on presently known structural and/or functional equivalents may be made without departing from the scope of the invention.

Given the following detailed description, it should become apparent to the person having ordinary skill in the art that the invention herein

### BRIEF DESCRIPTION OF THE DRAWING

FIG. 1 is schematic view of a laminated fabric according to an embodiment of the invention.

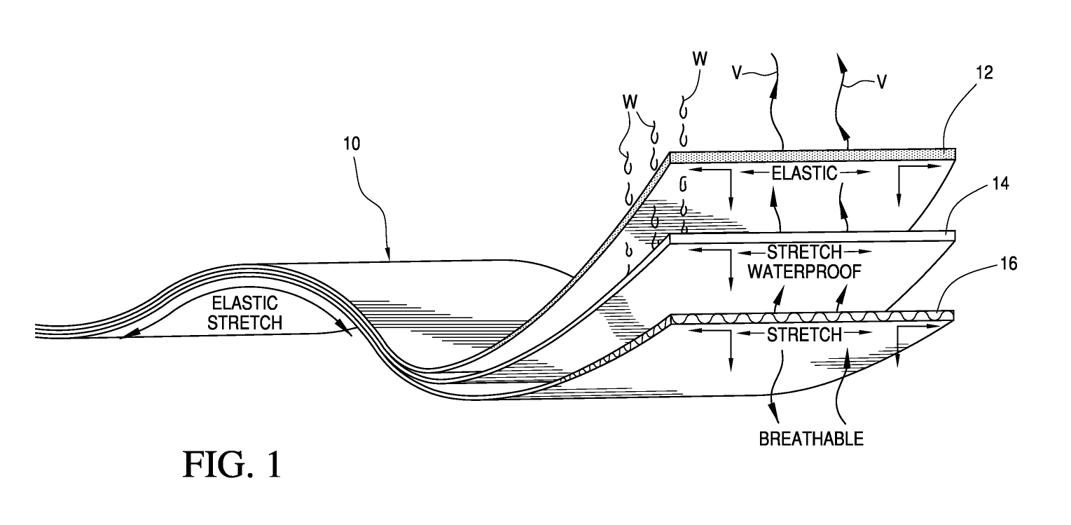

### DETAILED DESCRIPTION OF THE ILLUSTRATED EMBODIMENT

The illustrated embodiment depicts a laminated fabric 10 with a stretchable polyester/spandex outer shell layer 12; a vapor-permeable, waterproof, stretchable membrane 14; and, an inner polypropylene/spandex layer 16.

The polyester/elastomeric fiber outer shell fabric 12 is woven/knit/laid down (referred collectively as “knit” or “woven” herein) using conventional equipment and processes. The outer shell fabric weight, itself is between 4 oz to 12 oz./yd.² and preferably between 5 oz to 8 oz./yd.² and most preferably a 6.0 oz./yd.² The ratio of polyester fiber to elastomer fiber/spandex fiber should range from about 92%-75% but preferably falls in the range of 90%-80% and more preferably 85% polyester to 15% spandex. Generally, the resulting yarn is semi-dull and is a basic dyeable rather than disperse dyeable yarn. In order to provide adequate elasticity, the fabric is knitted from the yarn on a circular knit machine and is done so to provide as much stretch in the final product as possible.

Following weaving/knitting, the resulting material is scoured/de-oiled, framed, heat set, and exposed to sublimation dyes of a select pattern and/or array of colors by appropriate dye sublimation equipment. The knit fabric is first heat set before dyeing and then jet dyed. Afterwards, the dye-sublimated polyester/spandex fabric is finished (brushed, top-coated, etc.) as desired prior to lamination to the membrane 14 and polypropylene layer 16. The dyed, finished polyester shell fabric is tested to insure that it is soft and pliable. In this manner any select texture, pattern, color, or image combination, capable of being laid down using conventional techniques and apparatus, can be imparted to the rugged, breathable, colorfast, stretchable, waterproof, laminated end-product of the invention.

The membrane 14 may be any waterproof but breathable material, which is either non-porous or porous. As described in the incorporated patents, one membrane material is polytetrafluoroethylene (PTFE) but an alternative membrane material is the non-porous laminate film Sympatex.®, from Sympatex Technologies GmbH, Inc. of Germany. As reported in the '924 and '074 patents, the preferred membrane thickness ranges from 10-15 μm.

Another example of an acceptable membrane is an MVT barrier monolithic membrane of hydrophilic polyurethane such as that available from Shawmut Corp. of West Bridgewater, Mass. One such stretch barrier film is sold under the name Darlexx®. The vapor-permeable, waterproof membrane 14 may be constructed from other materials such as a porous film of expanded polytetrafluoroethylene (Gore-Tex®) according to the techniques of U.S. Pat. No. 3,953,566, as described in the above-cited '924 and '074 patents. An alternative laminate film composite is a polyether polyurethane membrane available from Deerfield Urethane.

The membrane film may be bonded with adhesive or by heat fusion to outer polyester shell fabric 12 and inner polypropylene shell 16. One example of a lamination adhesive composite is a moisture-curable polyurethane applied by a gravure mechanism resulting in lay down density of about 5-12 gm/m², and preferably 8 grams per square meter. The lamination process may be accomplished using conventional single or dual pass roller type mechanized lines that apply the adhesive to the layers of fabric.

The membrane film may also be formed by the conventional “dot matrix method” allowing it to adhere to the woven, stretchable, polyester-based shell layer 12 and the inner polypropylene shell layer 16. The membrane resulting form the “dot” deposition method of the Sympatex® exhibits high abrasion resistance and flex tolerance. Sympatex®, a copolyether ester consisting of a plurality of recurrent intralinear long-chain ester units and short-chain ester units, is described more particularly in U.S. Pat. No. 4,493,870 (expressly incorporated herein by reference). One desirable characteristic of the above-mentioned Sympatex® film is that as temperature and humidity rises, the membrane expands, spreading the dots apart which results not only in reducing the insulating effect of the dots but also increasing the membrane's surface area to thereby increase the rate of moisture transfer (its Rₑₜ rating).

As a result of its favorable tactile organoleptic qualities, moisture-wicking capability, and vapor-permeablity, the polypropylene/elastomeric layer is disposed as the skin contacting, inner shell of the three layer laminated fabric. The inner shell layer 16 is a blend of continuous polypropylene filaments and another fiber having elastomeric properties such as a polyurethane fiber such as that sold as Spandex or Lycra® which is described in the incorporated '924 and '074 patents. The continuous polypropylene filaments, preferably, are of a fine size, no greater than about 150 denier and ideally no greater than 70 denier. (“Denier” is defining linear mass density as grams per 9000 meters). Preferably the elastomeric filaments comprise about 10% of the polypropylene layer and are laid up on the outer/membrane facing surface of the polypropylene. The resulting polypropylene fabric is brushed to “scratch” one surface thereof which is then laminated to the film on first pass. If desired, the brushed surface may also be subject to selected surface treatments, such as a corona treatment, before lamination to further enhance adhesion to the membrane 14.

What follows are specifications of an exemplary setup for production of for the polypropylene layer 16 of the laminated fabric 10 in the embodiment of a 110 denier jersey knit. The polypropylene knit is fabricated on a Relanit SE circular knit machine with 2664 needles a 28 cut and 30″ diameter. The fibers of polypropylene and spandex are proportionately divided on the machine feeds (either 100 or 72 feed machines) to provide a 90% polypropylene/10% spandex fabric that weighs 8.2 oz./liner yard and 51-53 inches in width. The knitted fabric is then carefully and smoothly rolled in a manner that prevents the fabric from being rolled under tension and prevents edge fold-over and creases (fabric bruises) that cause irreparable damage.

To verify consistency and insure proper production of the knit fabric the following setup test may be used. Count out 100 needles, unravel the polypropylene and spandex filaments. Make adjustments as necessary so that the setup produces the 12.5″ of polypropylene and 20.7″ of spandex. This test is executed for every production.

A finer denier variation of the foregoing is a 7 oz./linear yard Jersey knit (51″-53″ width) with 88% polypropylene and 12% spandex with or without anti-microbial additives. When produced according to the invention, the resulting laminated fabric provides stretch in excess of 190% in width and 160% in length without curling.

Due to polypropylene's well known resistance to color application and acceptance of patterns, the inner laminate layer typically is dyed black. Prior to knitting using conventional equipment (e.g., circular knitting machines) and processes of the polypropylene fabric, the constituent filaments are scoured to insure removal of residual oils from manufacturing and dying processes.

In manufacture of the fabric of this invention, it is preferred that the membrane layer 14 first be laminated to the inner layer 16 and then the outer shell polyester laminated to the bi-layer and finished with heat setting. For the purposes of simplifying the process, lamination of the inner polypropylene shell to the membrane may occur simultaneously or nearly simultaneously with the lamination step of the outer polyester shell to the membrane. In such a process, whether performed on a single or multipass system, it is important to be aware that the temperature and pressure conditions are chosen to avoid damaging any of the constituent layers during lamination and also that the conditions in the case of a multiple roller process may not be identical. It is also preferred that the membrane adhering surface of the inner layer be both napped to promote adhesion and cleansed of contaminants to reduce curling during heat lamination. This process may utilize a single or dual pass roller system.

The resulting laminated fabric 10 may then be subject to known cut, make, and trim (CMT) processes to construct apparel. The apparel may be sewn, glued, welded, etc. with known, conventional techniques and equipment. Furthermore, when desirable or necessary, due to the intended use of the apparel the seams may be waterproofed and or sealed against exposure to ambient conditions (water, atmosphere, etc.).

In the context of alternative embodiments of the invention, so long as the inner polypropylene layer maintains the favorable characteristics of feel, elasticity, and vapor-permeability, structural variations and additions may be incorporated to achieve better select performance of the ultimate laminate. For example, it is possible to embed a strength reinforcing mesh, specialized nano-materials and even electrically conductive elements/leads. The layer may be doped with elutable or static constituents to enhance specific desirable properties (e.g., antimicrobial, flame retardancy, electro-magnetic field shielding, etc.).

Although a specific embodiment of the invention has been described herein, it is understood by those skilled in the art that other modifications and embodiments of the invention will come to mind to which the invention pertains, having benefit of the teaching presented in the foregoing description and associated drawings. For example, in addition to providing the polyester layer with a heat reflective color such as silver, the laminate may incorporate fire retardant materials to improve utility in the fire fighting field. Other variations particularly adaptable for first responders may incorporate constituents resistant to particular hazardous conditions (anti bacterial agents, anti-corrosives, etc.) to resist exposure to harmful chemical or biological agents. It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

We claim:

1. An improved breathable, stretchable, waterproof, printed laminated fabric with a first layer comprised substantially of polypropylene filaments blended with elastomeric fibers, which layer substantially resists absorption of liquid water, and a second layer, laminated to said first layer, said second layer being stretchable and substantially impervious to liquid water but pervious to water vapor, the improvement comprising a third layer of dye-sublimatable, polyester-elastomer fiber blend accepting desired coloration and patterning.

2. The fabric of claim 1, wherein the ratio of polyester to elastomer is from 90:10-80:20 and said polyester is basic dyeable.

3. The fabric of claim 1 which is cut, made, trimmed, and connected to form apparel.

4. A laminated fabric for use in constructing apparel, comprising:
a first stretchable fabric layer of a blend of polypropylene filaments and an elastomeric fiber;
a second layer of a waterproof, breathable, stretchable membrane having a first bondable surface and a second bondable surface where said first fabric layer is and laminated to said first bondable surface of said second layer; and
a third stretchable layer of a woven, dye-sublimated polyester-elastomeric yarn bonded to the second bondable surface of the second layer.

5. The laminated fabric of claim 4 where the third layer is colorfast.

6. The laminated fabric of claim 4 where the elastomer of the first layer is spandex and the elastomer of the third layer is spandex and is knitted on a circular machine.

7. The laminated fabric of claim 6 where the second layer is selected from the group consisting of polytetrafluoroethylene, hydrophilic polyurethane, polyether urethane, and polyether ester.

8. The laminated fabric of claim 5 where the first layer has a first and a second surface and the second surface is brushed and said membrane is laminated to the second surface.

9. The method of making a breathable, stretchable, waterproof, fabric with imaging and coloration comprising the step of:
laminating a first stretchable fabric layer of a blend of polypropylene filaments and an elastomeric fiber, a second layer of a waterproof, breathable, stretchable membrane having a first bondable surface and a second bondable surface, and a third stretchable layer of dye-sublimated polyester elastomeric yarn, where the first fabric layer is laminated to said first bondable surface of said second layer and the third stretchable layer is laminated to the second surface of the second layer.

10. The method of claim further comprising the step of coloring the third layer by dye sublimation prior to laminating the fabric.

11. The method of claim where the polyester elastomeric yarn is produced by a technique selected from the group of weaving, knitting or lay down.

12. The method of making apparel comprising the steps of:
fabricating a laminated fabric comprising a dye-sublimated, stretchable polyester-based layer, a waterproof and vapor permeable stretchable membrane, and a stretchable polypropylene-based layer,
cutting and trimming the laminated fabric into discrete pieces, and
attaching said discrete pieces by a known technique selected from the group consisting of sewing, gluing, and welding to form apparel.
